(19) United States
(12) Patent Application Publication
(10) Pub. No.: US 2023/0282943 A1
(43) Pub. Date: Sep. 7, 2023

(54) Nonwoven Fabric Separator

(71) Applicant: Asahi Kasei Kabushiki Kaisha, Tokyo (JP)

(72) Inventors: Junichi Kusakabe, Tokyo (JP); Maiko Sakuraba, Tokyo (JP); Takashi Komatsu, Tokyo (JP); Eiji Shiota, Tokyo (JP)

(73) Assignee: Asahi Kasei Kabushiki Kaisha, Tokyo (JP)

(21) Appl. No.: 18/005,426

(22) PCT Filed: Jul. 12, 2021
(86) PCT No.: PCT/JP2021/026187

§ 371 Date: Jan. 13, 2023

(30) Foreign Application Priority Data
Jul. 14, 2020 (JP) 2020-120463

(51) Int. Cl. H01M 50/497; H01M 50/417; H01M 50/491; H01M 50/494; H01M 10/24

(52) U.S. Cl. CPC H01M 50/497; H01M 50/417; H01M 50/491; H01M 50/494; H01M 10/24

(57) ABSTRACT

The present invention provides a nonwoven fabric separator which has excellent ion permeability. The present invention provides a nonwoven fabric separator which contains a polyolefin-based nonwoven fabric, wherein the permeability parameters expressed by formulae (1) and (2) are satisfied. (1): |Pmax|≤38.5 dB (2): Tmax≤11.5 minutes (In the formulae, both Pmax and Tmax are parameters each indicating a permeability, and Pmax shows the attenuation degree of ultrasound transmission in a state where the nonwoven fabric separator is filled with water, while Tmax shows the time until the nonwoven fabric separator is filled with water.)

### FIELD

The present invention relates to a nonwoven fabric separator.

### BACKGROUND

In recent years, with the diversification of electronic devices, there is a demand for higher performance in various electricity storage devices. Particularly, automotive power devices, which are required to be environmentally friendly, are equipped with nickel-hydrogen cells or lithium-ion cells in addition to conventional lead storage cells. In addition to high performance such as high output and low resistance, high reliability is required.

Conventionally, nonwoven fabrics and microporous membranes are widely used as electricity storage device separators. Functions of a separator include having electrical insulation property to prevent short-circuiting due to physical contact between electrodes and having appropriate strength. Further, since nickel-hydrogen cells, nickel-cadmium cells, and lead storage cells use strongly basic or strongly acidic electrolytic solutions as electrolytes, a separator is required to have chemical stability against these electrolytic solutions, have excellent wettability and liquid retention with electrolytic solutions, and not significantly impede ion permeability between electrodes. Particularly, in nonwoven fabric structures, there is a trade-off relationship between electrical insulation property (short-circuit resistance) and ion permeability, and separators are required to have both of these properties. For example, in an alkaline battery separator, a KOH aqueous solution is used as the electrolytic solution, and a polyolefin-based wet-type staple nonwoven fabric is used as the separator.

PTL 1 discloses an alkaline battery separator composed of a nonwoven fabric that is composed of 40 to 70% by mass of a high-strength composite adhesive fiber having a tensile strength of 5 cN/dtex or more and 30 to 60% by mass of an ultrafine fiber having a fiber diameter of 2 to 5 to which the high-strength composite adhesive fiber is bonded and three-dimensionally entangled, wherein the alkaline battery separator has a basis weight of more than 50 g/m², a specific surface area of 0.70 m²/g or more, and a breaking strength of 150 N/5 cm or more.

PTL 2 discloses an alkaline battery separator substrate comprising a nonwoven fabric laminate obtained by laminating a spunbonded polyolefin nonwoven fabric having a fiber diameter of 8 to 30 μm, a basis weight of 5 to 30 g/m², and a tensile strength of 2 to 20 kg/5 cm and a meltblown polypropylene nonwoven fabric having a fiber diameter of 6 to 20 μm, a basis weight of 5 to 30 g/m², and a tensile strength of 0.1 to 2 kg/5 cm, wherein the fiber diameter (Ds) of the spunbonded nonwoven fabric and the fiber diameter (Dm) of the meltblown nonwoven fabric have a ratio (Ds/Dm) of 1.5<(Ds/Dm)<3.

### CITATION LIST

### Patent Literature

[PTL 1] Japanese Unexamined Patent Publication (Kokai) No. 2017-033678
[PTL 2] Japanese Unexamined Patent Publication (Kokai) No. 2001-143682

### SUMMARY

### Technical Problem

PTL 1 specifies the amount of ultrafine fibers, and describes that ultrafine fibers help prevent short-circuiting due to dendrites. However, in the technique described in PTL 1, the ultrafine fibers and the composite adhesive fibers have a highly three-dimensionally entangled structure, and it is assumed that that ion permeability in the electrolytic solution decreases in the thickness direction of the separator. Further, PTL 2 specifies the fiber diameter and basis weight of each layer, and teaches a nonwoven fabric separator having high strength and excellent short-circuit suppression. However, PTL 2 does not focus on the behavior of the separator in the electrolytic solution. It is difficult to achieve both ion permeability and short-circuit resistance simply by adjusting the basis weight and fiber diameter.

In view of the problem described above, an object of an aspect of the present invention is to provide a nonwoven fabric separator that achieves both excellent ion permeability and excellent short-circuit resistance.

### Solution to Problem

The present disclosure encompasses the following aspects.
[1] A nonwoven fabric separator comprising a polyolefin-based nonwoven fabric, wherein the nonwoven fabric separator satisfies permeability parameters of formulas (1) and (2) below:

|Pmax|≤38.5 dB (1)

Tmax≤11.5 min (2)

where in the formulas, both Pmax and Tmax are parameters indicating permeability, Pmax indicates attenuation of ultrasonic transmission when the nonwoven fabric separator is filled with water, and Tmax indicates time until the nonwoven fabric separator is filled with water.
[2] The nonwoven fabric separator according to [1], wherein the nonwoven fabric separator is a filament nonwoven fabric separator.
[3] The nonwoven fabric separator according to [1] or [2], wherein the nonwoven fabric separator comprises ultrafine fibers having a fiber diameter of 0.1 μm to 5 μm.
[4] The nonwoven fabric separator according to [3], wherein the nonwoven fabric separator is composed of at least two layers, comprising a nonwoven fabric layer (layer I) made of the ultrafine fibers and a nonwoven fabric layer (layer II) made of fibers having a fiber diameter of more than 5 μm and 30 μm or less.
[5] The nonwoven fabric separator according to [4], wherein the nonwoven fabric separator is composed of three layers having two layers of the layer II and the layer I disposed between the layers II.
[6] The nonwoven fabric separator according to [4] or [5], wherein the layer I is a meltblown nonwoven fabric layer.
[7] The nonwoven fabric separator according to any of [4] to [6], wherein a ratio (i)/(ii) of a basis weight (i) of the layer I to a basis weight (ii) of the layer II is 1/20 to 2/1. [8] The nonwoven fabric separator according to any of [1] to [7] having a mean flow pore size of 0.1 μm to 50 μm and a bubble point of 5 μm to 100 μm.
[9] The nonwoven fabric separator according to any of [1] to [8] having an airflow resistance of 0.1 kPa·s/m to 15 kPa·s/m.
[10] The nonwoven fabric separator according to any of [1] to [9] having a porosity of 30% to 95%.
[11] The nonwoven fabric separator according to any of [1] to [10] having a tensile strength of 15 N/50 mm to 300 N/50 mm.
[12] The nonwoven fabric separator according to any of [1] to [11] comprising a hydrophilic functional group.
[13] The nonwoven fabric separator according to any of [1] to [12] having a thermocompression bonding area ratio of 20% or less.
[14] The nonwoven fabric separator according to any of [1] to [13] having a compression ratio of 35% or greater.
[15] The nonwoven fabric separator according to any of [1] to [14] having a light transmittance of 70% or greater.
[16] The nonwoven fabric separator according to any of [1] to [15], wherein a lowest porosity in a porosity distribution in a thickness direction is 20% or greater.

### Advantageous Effects of Invention

According to an aspect of the present invention, a nonwoven fabric separator having excellent ion permeability and excellent short-circuit resistance can be provided.

### DESCRIPTION OF EMBODIMENTS

Hereinafter, the present invention will be described in more detail for the purpose of exemplifying representative embodiments thereof. However, the present invention is not limited to these embodiments. Unless specified otherwise, it is intended that the values of various characteristics mentioned in the present disclosure be values measured by methods described in the [Examples] section of the present disclosure or by methods understood as equivalent thereto by a person skilled in the art.

The nonwoven fabric separator of the present embodiment comprises a polyolefin-based nonwoven fabric, wherein the nonwoven fabric separator satisfies permeability parameters of formulas (1) and (2) below.

|Pmax|≤38.5 dB (1)

Tmax≤11.5 min (2)

The permeability parameter is a value that indicates the permeability of a nonwoven fabric separator to water or the permeability of ions in a state where water has permeated the nonwoven fabric separator, and is obtained by measuring transmission intensity of ultrasonic waves emitted from an ultrasonic transmitter from the time when a target solution starts to permeate into the nonwoven fabric separator. Ultrasonic transmissibility changes depending on the state of liquid permeation into the nonwoven fabric separator. By replacing the air in the gaps inside the nonwoven fabric separator with the liquid permeating from the surface, density increases and the ultrasonic transmissibility improves. Further, when the solution has completely permeated (i.e., the gaps in the nonwoven fabric separator are filled with the solution), the ultrasonic transmissibility value according to the material and structure of the nonwoven fabric separator itself can be obtained, and can be used as an indicator for the ion permeability of the nonwoven fabric separator.

The permeability parameter |Pmax| of the nonwoven fabric separator of the present embodiment is a value evaluated using water as the solution, and is 38.5 dB or less in one aspect. The |Pmax| of the present disclosure indicates attenuation of ultrasonic transmission when the nonwoven separator is filled with water (i.e., completely permeated with water), and is an indicator representing the ion permeability in the electrolytic solution of the nonwoven fabric separator. A lower |Pmax| indicates a higher ion permeability of the nonwoven fabric separator. When |Pmax| is more than 38.5 dB, the ion permeability is significantly reduced and the resistance between electrodes is increased. From such a viewpoint, the upper limit value of |Pmax| is 38.5 dB in one aspect, and from the viewpoint of suppressing resistance of a storage cell, can preferably be 38 dB or less, 35 dB or less, 30 dB or less, or 15 dB or less. Although the lower limit value is not particularly limited, there is a trade-off relationship between ion permeability and short-circuit resistance of the nonwoven fabric separator. From the viewpoint of obtaining a desired short-circuit resistance, the lower limit value is substantially, for example, 1 dB or more, 5 dB or more, or 10 dB or more.

The permeability parameter Tmax of the nonwoven fabric separator of the present embodiment is a value evaluated using water as a solution, and is 11.5 min or less in one aspect. The Tmax of the present disclosure indicates time until the nonwoven fabric separator is filled with water (i.e., until water has completely permeated), and is an indicator for the affinity of the nonwoven fabric separator to an electrolytic solution. A smaller Tmax indicates a higher electrolytic solution permeability of the nonwoven fabric separator. When Tmax is more than 11.5 min, the affinity of the nonwoven fabric separator to the electrolytic solution deteriorates, leading to an increase in resistance between electrodes and a decrease in capacity appearance rate of a storage cell. A decrease in capacity appearance rate is a fatal defect for a storage cell. From such a viewpoint, the upper limit value of Tmax is preferably 11 min or less, 10 min or less, 5 min or less, or 1 min or less. The lower limit value is not particularly limited, but can be equal to or more than 0.3 s, which is the detection limit of a device.

The permeability parameters |Pmax| and Tmax vary depending on the structure of the nonwoven fabric separator and the affinity thereof to an electrolytic solution. Regarding the structure of the nonwoven fabric separator, it is preferable that the nonwoven fabric separator include a fiber layer having a straight pore structure in the thickness direction so that the values of permeability parameters |Pmax| and Tmax can be reduced. The straight pore structure in the thickness direction means a pore structure in which ions can migrate within the nonwoven fabric separator in the thickness direction (this is indicated as propagation of ultrasonic waves in the measurement of the permeability parameters). Structures that change the permeability parameters (i.e., change the mobility when ions migrate within the nonwoven fabric separator in the thickness direction) include size and distribution of gaps between fibers, the diameters of the fiber themselves (i.e., the wraparound distance at the time of an ion collision) and the distribution thereof, and the total thickness of the nonwoven (i.e., ion migration distance). Regarding the affinity of the nonwoven fabric separator to an electrolytic solution, it is preferable that the nonwoven fabric separator include a fiber surface having a small interfacial energy difference with the electrolytic solution so that the values of permeability parameters |Pmax| and Tmax can be reduced.

In the present embodiment, the layer configuration, basis weight, fiber dispersion state, gaps, thickness, fiber diameter, collection method, calendering method, and hydrophilization conditions of the nonwoven fabric separator are adjusted to control the pore structure of the fiber layers, whereby the permeability parameters |Pmax| and Tmax can be adjusted to the ranges of the present disclosure. Particularly, obtaining a bulky nonwoven fabric is desirable, and by adjusting the cooling conditions and/or collection conditions during collection, a bulky nonwoven fabric can be obtained without promoting fusion between yarns or having a dense network structure. Further, the SP value (solubility parameter) acts as a criterion for the affinity of the fiber surface to an electrolytic solution. In the present embodiment, treatment time and treatment concentration during hydrophilization, which will be described below, can be adjusted to adjust the SP value, and the permeability parameters |Pmax| and Tmax can be thereby adjusted to the ranges of the present disclosure. The depth of the hydrophilization of the nonwoven fabric separator may be adjusted so that the hydrophilization treatment can be carried out stably for a long time and damage to the nonwoven fabric separator is reduced.

The nonwoven fabric separator of the present embodiment comprises a polyolefin-based nonwoven fabric (specifically a nonwoven fabric composed of a polyolefin-based resin). Compared to other materials, polyolefin resins have considerably high chemical resistance (strong resistance to acids and bases) and very high chemical stability in various electrolytic solutions. Therefore, a nonwoven fabric separator made from polyolefin-based fibers do not undergo decomposition reactions even when used in nickel-hydrogen cells at relatively high temperatures that are expected for automotive applications, and the strength of the nonwoven fabric does not deteriorate. Since such a nonwoven fabric separator can maintain a long-term separator structure inside a storage cell, performance stability can be expected and cycle characteristics can be improved. Examples of the polyolefin-based resin include homopolymers and copolymers of α-olefins such as ethylene, propylene, 1-butene, 1-hexene, 4-methyl-1-pentene, and 1-octene; high-pressure low-density polyethylene, linear low-density polyethylene (LLDPE), high-density polyethylene, polypropylene (propylene homopolymer), polypropylene random copolymer, poly 1-butene, poly 4-methyl-1-pentene, ethylene/propylene random copolymer, ethylene/1-butene random copolymer, and propylene/1-butene random copolymer. Polypropylene and polyethylene are preferable.

Two or more resins have different melting points from the above polyolefin-based resins can be used. Two or more resins have different melting points may be included in one fiber. For example, a sheath-core yarn consisting of a core and a sheath, in which the melting point of the thermoplastic resin of the sheath is lower than the melting point of the thermoplastic resin of the core, can be used to obtain a high-strength nonwoven fabric separator.

The nonwoven fabric separator of the present embodiment is preferably a filament nonwoven fabric separator (specifically, a separator of a nonwoven fabric made of continuous filaments). In the present disclosure, a continuous filament refers to a fiber specified in JIS-L0222. Nonwoven fabrics made of staples tend to have low strength since fibers are discontinuous and a single yarn has low strength, and may break due to process tension in each process. Further, fibers may fall off during processing such as slitting, which may lead to defects. On the other hand, a nonwoven fabric made of continuous filaments has very high strength and retains strength satisfactorily even in an electrolytic solution, and thus has excellent resistance to burrs on an electrode and movement of an electrode active material in electrical reactions, which is advantageous as a storage cell separator.

In the nonwoven fabric separator of the present embodiment, the lowest porosity in the porosity distribution in the thickness direction is preferably 20% or greater, more preferably 30% or greater, even more preferably 40% or greater, and most preferably 50% or greater. By setting the lowest porosity in the porosity distribution in the thickness direction to 20% or greater, |Pmax| and Tmax are easily set within the ranges described above, and ion permeability and short-circuit resistance, which are conflicting parameters, are both easily achieved. In one aspect, the upper limit of the lowest porosity in the porosity distribution in the thickness direction is technically 95%.

The nonwoven fabric separator of the present embodiment preferably comprises ultrafine fibers having a fiber diameter of 0.1 to 5 μm, whereby a nonwoven fabric separator having excellent voltage resistance can be obtained, and short-circuit resistance that is most necessary for a separator can be exhibited. Further, the above ultrafine fibers can form an extremely dense layer, and are thus advantageous in manufacturing a nonwoven fabric separator having low resistance. When the fiber diameter is 5 μm or less, inter-fiber gaps do not excessively increase, and short-circuiting, which is a fatal defect for storage cells, can be more reliably prevented. When the fiber diameter is 0.1 μm or more, ion permeability in an electrolytic solution can be satisfactorily maintained. From the above viewpoints, the fiber diameter of the ultrafine fibers is more preferably 0.2 μm to 4.5 μm, and even more preferably 0.3 μm to 4.0 μm.

The nonwoven fabric separator of the present embodiment is preferably formed of at least two layers comprising a nonwoven fabric layer (layer I) made of ultrafine fibers having a fiber diameter of 0.1 to 5 μm and a nonwoven fabric layer (layer II) made of fibers having a fiber diameter of more than 5 μm and 30 μm or less. In this case, the nonwoven fabric layer (layer I) made of ultrafine fibers having a fiber diameter of 0.1 to 5 μm is a functional layer, and the nonwoven fabric layer (layer II) made of fibers having a fiber diameter of more than 5 μm and 30 μm or less acts as a strength layer. According to the laminated nonwoven fabric including two or more layers combining the nonwoven fabric layer (layer I) and the nonwoven fabric layer (layer II), a denser and network-like nonwoven fabric structure can be formed compared to when each layer is used alone as a separator. As a result, spaces that can be filled with a large amount of electrolytic solution more uniformly can be formed. Particularly, in one aspect, since the nonwoven fabric layer (layer I) is arranged in the gaps between fibers constituting the nonwoven fabric layer (layer II), the fibers are arranged more uniformly. In this case, the retention of the electrolytic solution is improved, and the contact area between the electrolytic solution and an electrode surface at the interface between an electrode and the nonwoven fabric separator, which has a large amount of gap spaces, increases, enabling effective electrode reactions, which results in higher capacity and longer life for a storage cell. Further, the nonwoven fabric separator including at least two layers as described above has high separator strength due to the layer II, which is a strength layer, thereby not only making post-processing easy but also productivity very high. From the above viewpoints, a two-layer structure of layer I-layer II, a three-layer structure o layer I-layer II-layer I, a three-layer structure of layer II-layer I-layer II (specifically, a three-layer structure in which a layer I is arranged between two layers II), and a four-layer structure of layer I-layer II-layer I-layer II are preferable. Of these, a three-layer structure of two layers II and a layer I arranged between the layers II has particularly excellent handleability due to a configuration of the outer layers of the nonwoven fabric separator being strength layers and is preferable.

The manufacturing method of each nonwoven fabric layer used in the present embodiment is not limited. However, the production method for the nonwoven fabric layer (layer II) is preferably a spunbond method, a dry method, or a wet method. The fiber constituting the nonwoven fabric layer (layer II) may be a thermoplastic resin fiber. Further, the production method for the nonwoven fabric layer (layer I) made of ultrafine fibers is preferably a production method such as a dry or wet method using the ultrafine fibers, or an electrospinning method, a meltblown method, or a force spinning method. From the viewpoint that a nonwoven fabric layer made of ultrafine fibers can be easily and densely formed, it is particularly preferable that the nonwoven fabric layer (layer I) be a meltblown nonwoven fabric layer. Furthermore, the fibers may be split or fibrillated by beating or partial dissolution and then used to manufacture the nonwoven fabric.

Examples of a method for forming a laminated nonwoven fabric by laminating a plurality of layers having a nonwoven fabric layer (layer I) made of ultrafine fibers and a nonwoven fabric layer (layer II) that may be composed of thermoplastic resin fibers include a method of integration by thermal bonding, a method of three-dimensional entanglement by jetting high-speed water streams, and a method of integration with a particulate or fibrous adhesive. Of these, forming the laminated nonwoven fabric by integration via thermal bonding is preferable. Examples of the method of integration by thermal bonding include integration by thermal embossing (thermal embossing roll method) and integration by high-temperature hot air (air-through method). Integration by thermal bonding is preferable from the viewpoint that tensile strength, bending flexibility, and heat resistance stability can be maintained.

Integration by thermal bonding is preferable in that a laminated nonwoven fabric having a plurality of nonwoven fabric layers can be formed without using a binder. If a binder is used when fibers are integrated to form a laminated nonwoven fabric, the binder may be eluted in the electrolytic solution. Although there is no problem if the binder is not involved in an electrode reaction and does not affect cell performance, the electrode reaction may be affected depending on the binder and the desired capacity or voltage cannot be obtained. Further, when the pore structure specific to the nonwoven fabric is blocked by the binder, the effect of electrolytic solution retention may be reduced. For the above reasons, a nonwoven fabric that is integrated by heat only and does not use a binder is preferable. Furthermore, from the viewpoint of rationality of a step of forming the laminated nonwoven fabric, integration by heat only is preferable in that cost can be further reduced.

Integration by thermal bonding can be achieved by thermally bonding two or more nonwoven layers. The thermal bonding step can be carried out, for example, by bonding nonwoven fabric layers at a temperature 50 to 120° C. lower than the melting point of the constituent resin, at a linear pressure of 100 to 1000 N/cm, using a flat roll. When the linear pressure in the thermal bonding step is 100 N/cm or more, satisfactory adhesion can be obtained and satisfactory strength can be exhibited. When the linear pressure is 1000 N/cm or less, deformation of the fibers does not increase, and a decrease in porosity due to an increase in apparent density can be avoided, which is advantageous from the viewpoint of remarkably obtaining the advantages of the present embodiment.

The most preferable method of forming the laminated nonwoven fabric according to the present embodiment is a method in which a spunbonded nonwoven fabric layer and a meltblown nonwoven fabric layer and/or spunbonded nonwoven fabric layer are manufactured in sequence, laminated, and pressed by an embossing roll or a heat-press roll. This method can form a laminated nonwoven fabric with the same material and can be produced on a continuous integrated production line, and is thus preferable when the purpose is to obtain a uniform nonwoven fabric having a low basis weight. Specifically, a method in which one or more spunbonded nonwoven fabric layers are spun on a conveyor using a thermoplastic resin and one or more ultrafine fiber nonwoven fabric layers having a fiber diameter of 0.1 to 5 μm are sprayed thereon by a meltblown method using a thermoplastic resin, the one or more layers of nonwoven fabrics composed of thermoplastic resin fibers using the thermoplastic resin are then laminated, and these layers are integrated by pressing using an embossing roll or a flat roll is preferable.

When the above production method is used, the meltblown ultrafine fiber nonwoven fabric layer (layer I) is directly sprayed onto the nonwoven fabric layer (layer II) composed of thermoplastic resin fibers. Thus, the meltblown ultrafine fiber nonwoven fabric layer (layer I) can penetrate into the nonwoven fabric layer (layer II) composed of thermoplastic resin fibers. As such, the meltblown ultrafine fibers penetrate into and are fixed in the nonwoven fabric layer (layer II) composed of thermoplastic resin fibers, whereby not only is the strength of the laminated nonwoven fabric structure itself improved, but since the ultrafine fiber nonwoven fabric layer (layer I) does not move easily by external forces, gaps within the nonwoven fabric layer (layer II) composed of thermoplastic resin fibers can also be uniformized by the ultrafine fiber layer. Consequently, the formation of a laminated nonwoven fabric having an appropriate distance between fibers and an appropriate pore size distribution is facilitated. Specifically, according to the above method, in the laminated nonwoven fabric, a portion of the layer I penetrates into the layer II and a continuous layer I can be maintained, facilitating electrolytic solution retention or ion permeability within the surface of the nonwoven fabric. To set the lowest porosity in the porosity distribution in the thickness direction to 20% or more, adjusting the suction air speed on a collection net when collecting the layer I is particularly effective. Specifically, the suction air speed is preferably 10 m/sec to 43 m/sec, and more preferably 13 m/sec to 21 m/sec.

When the nonwoven fabric separator of the present embodiment comprises a laminated nonwoven fabric, the ratio ((i)/(ii)) of the basis weight (i) of the nonwoven fabric layer (layer I) to the basis weight (ii) of the nonwoven fabric layer (layer II) of the laminated nonwoven fabric is not limited to the following, but is preferably 1/20 to 2/1 to impart satisfactory strength to the nonwoven fabric separator and to form a dense structure having small inter-fiber gaps. When the value of the above ratio is 1/20 or greater, the relative basis weight of the layer I does not excessively decrease, and thus the layer I is easily formed in a planar direction of the nonwoven fabric. When the value of the above ratio is 2/1 or less, the relative basis weight of the layer II is large, and thus the nonwoven fabric separator can be imparted with satisfactory strength that makes deformation or breakage difficult in each process such as slitting or winding. Note that, in the case of two or more layers I present in the nonwoven fabric separator, the above basis weight (i) is the total basis weight thereof, and in the case of two or more layers II present in the nonwoven fabric separator, the above basis weight (ii) is the total basis weight thereof. Further, the basis weight of each layer, when measurement thereof is difficult, can be calculated by referring to the discharge volume of each layer during the manufacture of the nonwoven fabric separator.

In one aspect, the basis weight (i) of layer I in the nonwoven fabric separator is preferably 0.8 to 45 g/m², 1 to 40 g/m², or 2 to 30 g/m².

In one aspect, the basis weight (ii) of layer II in the nonwoven fabric separator is preferably to 65 g/m², 7 to 60 g/m², or 10 to 55 g/m².

The mean flow pore size of the nonwoven fabric separator of the present embodiment is preferably 0.1 μm to 50 μm. When the mean flow pore size is 50 μm or less, internal short-circuiting between electrodes does not easily occur, and cell characteristics are satisfactory. Further, when the mean flow pore size is 0.1 μm or more, ion permeability between electrodes does not excessively decrease, and a low resistance value as a separator can be maintained. From the above viewpoints, the mean flow pore size of the nonwoven fabric separator is more preferably 0.3 μm to 40 μm, and even more preferably 0.5 μm to 30 μm. Moreover, the corresponding bubble point is preferably 5 μm to 100 μm, and more preferably 10 μm to 80 μm.

The thickness of the nonwoven fabric separator of the present embodiment is preferably 30 to 300 μm, and the basis weight is preferably 10 to 100 g/m². When the thickness is 300 μm or less, the distance between electrodes does not excessively increase, and a low resistance can be maintained. Further, when the thickness is 300 μm or less, the thickness per cell does not excessively increase, and consequently, the number of cells that can be mounted in an entire storage cell can be increased to increase capacity. When the thickness is 30 μm or more, resistance against active material movement during electrode reactions is satisfactory and short-circuiting does not easily occur. From the above viewpoints, the thickness is more preferably 40 to 250 μm, and even more preferably 50 to 200 μm. Moreover, when the basis weight is 100 g/m² or less, the thickness of the entire nonwoven fabric separator is easily set to a preferable range. When the basis weight is 10 g/m² or more, the strength of the nonwoven fabric separator is satisfactory. For example, it is possible for the nonwoven fabric separator to have satisfactory strength even when the electrodes are held in a bag shape thereby. From the above viewpoints, the basis weight is more preferably 15 to 80 g/m², and even more preferably 20 to 60 g/m².

The porosity of the nonwoven fabric separator of the present embodiment is preferably 30 to 95%. It is preferable from the viewpoints of permeability of the electrolytic solution, ion permeability, liquid retention volume, cycle longevity, and short-circuit prevention that the porosity of the nonwoven fabric separator be within this range. The porosity of the nonwoven fabric separator can be set to, for example, 40 to 90%, 45 to 85%, or 50 to 80%.

The airflow resistance of the nonwoven fabric separator of the present embodiment is preferably 0.1 to 15 kPa·sec/m. When the airflow resistance is 15 kPa·sec/m or less, ion permeability is not inhibited, and a low resistance can be maintained. When the airflow resistance is 0.1 kPa·sec/m or more, micro-short-circuiting can be suppressed.

From the viewpoint of handleability and reduction of defect rate, the nonwoven fabric separator of the present embodiment preferably has a tensile strength of 15 to 300 N/50 mm. When the tensile strength is 300 N/50 mm or less, handling is satisfactory. When the tensile strength is 15 N/50 mm or more, rupture does not easily occur when an electrode is inserted, and resistance against process tension in each process is satisfactory. The tensile strength is more preferably 30 to 300 N/50 mm.

The nonwoven separator of the present embodiment preferably comprises a hydrophilic functional group. A hydrophilic functional group can be provided, for example, by a method of hydrophilizing a nonwoven fabric. When the hydrophilic functional group is present, an electrolytic solution is more easily retained in the gaps of the nonwoven fabric separator, and thus the permeability parameter |Pmax| and/or Tmax can be reduced. A nonwoven fabric separator comprising a hydrophilic functional group can provide a storage cell separator with excellent ion permeability and liquid retention of electrolytic solution, and a storage cell obtained using the nonwoven fabric separator can be imparted with excellent cell performance.

As the hydrophilization method, physical processing methods such as hydrophilization by corona treatment or plasma treatment; chemical processing methods such as introduction of a hydrophilic functional group, for example, introducing a sulfonic acid group or a carboxylic acid group by oxidation treatment; and processing with a treatment agent, such as a water-soluble polymer, for example polyvinyl alcohol (PVA), polystyrene sulfonic acid, or polyglutamic acid, and/or a surfactant, for example a nonionic surfactant, an anionic surfactant, a cationic surfactant, or a zwitterionic surfactant can be adopted. A person skilled in the art can select an appropriate hydrophilization method and conditions, such as the amount of treatment agent used and the amount of hydrophilic functional group introduced, in consideration of affinity to the electrolytic solution. The hydrophilization method is preferably introduction of a hydrophilic functional group by sulfonation. As a treatment method for the sulfonation treatment, any known treatment method such as a method with hot concentrated sulfuric acid, fuming sulfuric acid, or SO₃ gas can be suitably used.

The compression ratio of the nonwoven fabric separator of the present embodiment, from the viewpoint of improving adhesion between the electrode surface and the nonwoven fabric separator to maintain a low resistance value at the interface, is preferably 35% or greater, 38% or greater, or 40% or greater. In one aspect, from the viewpoint of handling, the compression ratio may be 90% or less, 85% or less, or 80% or less.

The nonwoven fabric separator of the present embodiment is preferably integrated by thermal bonding. For example, the nonwoven fabric is satisfactorily formed by thermally bonding the fibers constituting the nonwoven fabric layers via calendering. Examples of calendering include a method of pressing the nonwoven fabric layers with hot rolls. This method can be carried out in a continuous integrated production line, and is thus suitable for the purpose of obtaining a uniform nonwoven fabric with a low basis weight. The thermal bonding can be carried out, for example, at a temperature 50° C. to 120° C. lower than the melting point of the thermoplastic resin constituting the nonwoven fabric and a linear pressure of 100 to 1000 N/cm. The linear pressure in the calendering within the above range is preferable from the viewpoint of strength of the nonwoven fabric separator, reduction of fiber deformation, and reduction of apparent density, whereby a highly controlled pore distribution in the nonwoven fabric separator of the present embodiment is more easily achieved. The hot rolls used in the calendaring may be rolls having an uneven surface, such as embossed or satin-patterned rolls, or smooth flat rolls. The surface pattern of the rolls having an uneven surface is not limited as long as the fibers can be thermally bonded to each other, such as embossed patterns, satin patterns, rectangular patterns, and line patterns.

The thermocompression bonding area ratio of the nonwoven fabric separator of the present embodiment, from the viewpoint of improving ion permeability to lower resistance value of a storage cell, is preferably 20% or less, 15% or less, or 5% or less, or most preferably 0%. In one aspect, the thermocompression bonding area ratio may be 1% or greater, 2% or greater, or 3% or greater.

The light transmittance of the nonwoven fabric separator of the present embodiment, from the viewpoint of increasing ion permeability to obtain a high capacity, is preferably 70% or greater, 75% or greater, or 80% or greater. In one aspect, from the viewpoint of ease of manufacturing of the nonwoven fabric separator, the light transmittance may be 99% or less, 97% or less, or 95% or less.

The storage cell equipped with the nonwoven fabric separator of the present embodiment may be any storage cell as long as the storage cell uses an electrolytic solution. Examples of the storage cell using an electrolytic cell include lead storage cells, alkaline cells (nickel-cadmium cells, nickel-hydrogen cells), lithium-ion cells, electrolytic capacitors, and electric double-layer capacitors. Alkaline cells are particularly preferable. An alkaline cell uses a potassium hydroxide aqueous solution as the electrolytic solution, and is suitable with a nonwoven fabric separator composed of a polyolefin-based resin having chemical stability.

### EXAMPLES

Hereinafter, the present invention will be further specifically described with reference to the Examples. However, the present invention is not limited to the Examples thereof. Hereinafter, unless specified otherwise, the length direction of the nonwoven fabric is the MD (machine direction), and the width direction is a direction perpendicular to the length direction.

(1) Basis Weight (g/m²) and Ratio of Basis Weight (i)/Basis Weight (ii)

In accordance with the method prescribed in JIS L-1906, a test piece having a length of 20 cm by a width of 25 cm was sampled at 3 points per m in the width direction of the sample and 3 points per m in the length direction, totaling 9 points per square m to measure the mass, and an average value thereof was converted to mass per unit area to determine a basis weight. In addition, a ratio of basis weight (i)/basis weight (ii) was calculated from actual measurement of total basis weight based on the ejection amount ratio of each layer during manufacturing of the nonwoven fabric.

### (2) Thickness (μm)

In accordance with the method prescribed in JIS L-1906, thickness was measured at 10 points per m of width of a test piece, and an average value thereof was determined. Thickness was measured under the condition of a load of 9.8 kPa.

(3) Apparent Density (g/cm³)

Using the basis weight (g/m²) measured in (1) above and the thickness (mm) measured in (2) above, apparent density was calculated by the following formula with units adjusted:

Apparent density=(basis weight)/(thickness)

### (4) Porosity (%)

Using the apparent density (g/cm³) calculated in (3) above, porosity was calculated by the following formula:

Porosity={1−(apparent density)/(resin density)}/100

Note that, 0.94 (for polypropylene (PP) fibers), 0.94 (for polypropylene/polyethylene (PP/PE) core-sheath fibers), and 1.13 (for nylon (Ny) fibers) were used as density values of the corresponding resins.

### (5) Fiber Diameter (μm)

A nonwoven fabric separator was cut into 10 cm×10 cm, interposed from above and below with iron plates at 60° C., and pressed at a pressure of 0.30 MPa for 90 s, followed by vapor deposition of platinum. Using a scanning electron microscope (SEM) (JSM-6510 manufactured by JEOL Ltd.) under the conditions of an acceleration voltage of 15 kV and a working distance of 21 mm, the nonwoven fabric separator vapor-deposited with platinum was photographed. The photographing magnification was set to 10000 times for yarns having an average fiber diameter of less than 0.5 μm, 6000 times for yarns having an average fiber diameter of 0.5 μm or more and less than 1.5 μm, and 4000 times for yarns of 1.5 μm or more. The field of view at each magnification was set to 12.7 μm×9.3 μm for 10000 times, 21.1 μm×15.9 μm for 6000 times, and 31.7 μm×23.9 μm for 4000 times. 100 or more fibers were photographed at random, and all fiber diameters were measured. However, fibers that were fused together in the yarn length direction were excluded from measurement. The weight-average fiber diameter (Dw) determined by the following formula:

Dw=ΣWi·Di=Σ(Ni·Di²)/(Ni·Di)

where in the formula, Wi=weight fraction (=Ni·Di/ΣNi·Di) of fiber diameter Di, and Ni is the number of yarns having the fiber diameter Di,

was used as the fiber diameter (μm).

### (6) Pore Size Distribution (Mean Flow Pore Size and Maximum Pore Size)

A PMI palm porometer (model: CFP-1200AEX) was used. Silwick manufactured by PMI was used as the immersion liquid for the measurement. After a sample was immersed in the immersion liquid and sufficiently degassed, the sample was measured.

In the present measurement device, a filter is used as a sample, the filter is immersed in a liquid with a previously known surface tension, and pressure is applied to the filter in a state of having all pores of the filter covered with films of the liquid. The pore size of the pores is measured by calculating from the pressure at which a liquid film is ruptured and the surface tension of the liquid. The following formula is used for the calculation.

d=C·r/P

where in the formula, d (unit: μm) is the pore size of the filter, r (unit: N/m) is the surface tension of the liquid, P (unit: Pa) is the pressure at which a liquid film having the above pore size is ruptured, and C is a constant.

From the above formula, the flow rate (wet flow rate) is measured when the pressure P applied to the filter immersed in the liquid is continuously changed from a low pressure to a high pressure. At the initial pressure, the flow rate is zero since even a liquid film in the largest pore is not ruptured. As the pressure increases, the liquid film in the largest pore is ruptured and a flow occurs (bubble point). As the pressure further increases, the flow rate increases in response to each pressure. The flow rate at the pressure at which a liquid film in the smallest pore is ruptured corresponds to the flow rate in a dry state (dry flow rate).

In the measurement method by the present measurement device, the value obtained by dividing the wet flow rate at a certain pressure by the dry flow rate at the same pressure is called the cumulative filter flow rate (unit: %). The pore size of a liquid film ruptured at the pressure at which the cumulative filter flow rate is 50% is called the mean flow pore size.

The maximum pore size of the nonwoven fabric separator of the present disclosure was measured by using the nonwoven fabric separator as the above filter sample, and was used as the pore size of the liquid film ruptured in the −2σ range of 50% of the cumulative filter flow rate, i.e., at a pressure at which the cumulative filter flow rate is 2.3%. Each sample was measured at three points by the above measurement method, and as an average value thereof the mean flow pore diameter and the minimum and maximum pore sizes were calculated.

(7) Airflow Resistance (kPa·s/m)

Using a KES-F8-AP1 airflow resistance tester manufactured by Kato Tech Co., Ltd., airflow resistance (kPa·s/m) was measured from a differential pressure at an air permeability of 4 cm³/cm²·s.

### (8) Tensile Strength (N/50 mm)

Measurement was carried out based on JIS L1913. Specifically, excluding 10 cm from each edge of the sample (nonwoven fabric separator), test pieces having a width of 50 mm by a length of 20 cm were cut out at 5 points per m of width. A load was applied to each test piece until rupture, and an average value of the strength at maximum load of the samples in the MD was determined.

### (9) Dynamic Permeability Evaluation (Permeability Parameter)

The permeability parameters were calculated using a dynamic permeability tester (DPM 30) manufactured by Emco. The ultrasonic frequency was set to 2 MHz, the permeating solution was deionized water, and the water temperature was set to 25° C. The attenuation of ultrasonic transmission intensity was measured from contact start time, and the attenuation when the water completely permeated was calculated as Pmax and the time required there until was calculated as Tmax. When the ultrasonic transmission intensity when t (min) has passed since the nonwoven fabric separator was brought into contact with the water was designated as P(t), and the attenuation was designated as |P(t)|, the t that initially satisfies the following formula was designated as Tmax.

|P(t)|/|P(t−1)|≤1.05

### (10) Thermocompression Bonding Area Ratio Measurement

30 mm-squares were cut from any 20 points on the nonwoven fabric separator, and morphological images were taken using SEM at 50 times magnification. The photographed images were printed in A4 size. The area of the portions where the morphology of a compression-bonded portion was visually confirmed was determined, and a compression bonding area ratio was calculated.

### (11) Compression Ratio Measurement

Based on JIS-L1913 (compression ratio), the compression ratio was calculated by the following formula.

Compression ratio (%)=(To−T1)/To
To: Thickness (mm) when initial load (50 gf/cm²) was applied
T1: Thickness (mm) when final load (300 gf/cm²) was applied

### (12) Light Transmittance Measurement

An image analyzing-type formation tester, measurement device type: FMT-MIII manufactured by Nomura Shoji Co., Ltd., was used. The amounts of light when a light source was turned on and off were measured using a CCD camera without setting a sample (nonwoven separator). Subsequently, while a nonwoven separator cut into A4 size was set, the amounts of light were measured in the same manner to calculate an average transmittance. A two-step measurement method was adopted for calibration to eliminate external factors.

### (13) Minimum Porosity (%) in Porosity Distribution in Thickness Direction

A test piece of 5 mm in the MD by 5 mm in the CD was arbitrarily cut. At a field of view of about 0.65 mm×0.65 mm at the time of image analysis, the thickness of the test piece was measured so that the entire test piece was within field of view. A high-resolution 3D X-ray microscope, nano3DX (manufactured by Rigaku Corporation), was used as the measurement device, and CT measurements were carried out via low-energy high-intensity X-rays, which can provide contrast even for light elements. Detailed conditions are indicated as follows.
X-ray target: Cu
X-ray tube voltage: 40 kV
X-ray tube current: 30 mA
Lens: 0.27 μm/pix
Binning: 2
Rotation angle: 180°
Number of projections: 1000
Exposure time: 10 s/projection
Spatial resolution: 0.54 μm/pix

Based on the obtained X-ray CT image data, noise was removed by median filter, binarization was carried out by the Otsu method, regions were divided into fibers and spaces, and porosity at each position in the thickness direction was calculated by the following formula.

Porosity=number of pixels of spaces÷(number of pixels of fibers+number of pixels of spaces)×100

Thereafter, the lowest porosity in the thickness direction was used as the lowest porosity in the porosity distribution in the thickness direction.

### (14) Electrical Resistance Measurement (Ion Permeability)

A nonwoven separator was inserted between parallel platinum electrodes (platinum-blackened disk-shaped electrodes having a diameter of 20 mm) immersed in a 40% by mass KOH aqueous solution and spaced about 2 mm apart. The increase in electrical resistance between the electrodes due to this insertion was used as the electrical resistance of the nonwoven fabric separator. The electrical resistance between electrodes was measured using an LCR meter at a frequency of 1000 MHz.

### [Production of Electrode Group]

The nonwoven fabric separators of the Examples and Comparative Examples, which will be described below, were each interposed between a paste-like nickel positive electrode (40 mm width) using an open-cell nickel substrate as the current collector of the cell and a paste-like hydrogen occlusion alloy negative electrode (40 mm) to produce electrode pairs. A plurality of the electrode pairs were interposed between nonwoven fabric separators, whereby an electrode group was produced.

### [Production of Cell]

The electrode group produced as described above was housed in a cylindrical outer can, and an electrolytic solution (10% KOH aqueous solution) was injected therein. The outer can was sealed to produce a cylindrical nickel-hydrogen cell (capacity: 1.7 Ah). To chemically convert the obtained nickel-hydrogen cell, the cell was charged at 0.1 C at 25° C. for 15 min, which was repeated 5 times until the final voltage reached 0.8 V.

### (15) Measurement of Defect Rate (%)

In the production of a cell, a cell was determined to be defective if there was conduction between electrodes due to burrs at the ends of the electrodes or if there was short-circuiting due to breakage of the nonwoven fabric separator from penetration. The ratio of defective cells per 1000 was used as the defect rate (%).

### (16) Measurement of Capacity Retention Rate (%)

Using a chemically converted nickel-hydrogen cell obtained as described above, the discharge capacity (Ca) after charging at 1 C and the discharge capacity (Cb) after storing at 40° C. for 7 days were measured, and a capacity retention rate (%) was calculated by the following formula:

Capacity retention rate (%)=(Cb/Ca)×100

### (17) Evaluation of Cycle Characteristics

Using the chemically formed nickel-hydrogen cell obtained as described above, charging and discharging, in which one cycle included charging at 0.1 C, pausing for 15 min, and discharging at a discharge rate of 0.2 C until the final voltage reached 0.8 V, were repeated, and the number of cycles when the initial capacity was less than 80% was counted. A higher number of cycles indicates more excellent cycle characteristics. Cycle characteristics were rated “poor” if the number of cycles was 499 or less, “good” if 500 or more and 799 or less, and “excellent” if 800 or more.

### Examples 1 to 5, 10 to 15, 17 to 22, and 24 to 26

A nonwoven fabric layer (layer II) composed of thermoplastic resin fibers and having a fiber diameter of 15 μm was formed. Specifically, polypropylene was discharged from a spunbond spinneret (V-type nozzle) at a spinning temperature of 220° C. A yarn line was symmetrically cooled from both sides by cooling devices immediately below the spinneret (both at a wind speed of 0.5 m/s) and pulled by a draw jet to obtain a continuous filament. The filament was unraveled, dispersed, and deposited in a web conveyer form to form a web on a collection net. Next, a polypropylene (PP) solution was used and spun as an ultrafine fiber nonwoven fabric layer (layer I) under the condition of a spinning temperature of 220° C. by a meltblown method, and blown onto the above thermoplastic resin filament web. At this time, the distance from the meltblown nozzle to the thermoplastic resin filament web was set to 300 mm, the suction force on the collection surface immediately below the meltblown nozzle was set to 0.2 kPa, and the wind speed was set to 7 m/sec. A continuous filament nonwoven fabric (15 μm) produced by the same spunbond method as above was laminated thereon to obtain a nonwoven fabric composed of a layer II-layer I-layer II laminated structure. Further, the layers were integrated with a calender roll, and the thickness and apparent density were adjusted to obtain a desired thickness. Finally, the resulting nonwoven fabric was hydrophilized via a sulfonation treatment to obtain a nonwoven fabric separator. The suction air speed on the collection net during collection of layer I was adjusted to 13 m/sec for Examples 1 to 5, 10 to 15, and 17 to 22, 10 m/sec for Example 24, 21 msec for Example 25, and 43 m/sec for Example 26.

### Example 6

A nonwoven fabric layer (layer II) composed of thermoplastic resin fibers and having a fiber diameter of 15 μm was formed. Specifically, polypropylene was discharged from a spunbond spinneret (V-type nozzle) at a spinning temperature of 220° C. A yarn line was symmetrically cooled from both sides by cooling devices immediately below the spinneret (both at a wind speed of 0.5 m/s) and pulled by a draw jet to obtain a continuous filament. The filament was unraveled, dispersed, and deposited in a web conveyer form to form a web on a collection net. Next, a polypropylene (PP) solution was used and spun as an ultrafine fiber nonwoven fabric layer (layer I) under the condition of a spinning temperature of 220° C. by a meltblown method, and blown onto the above thermoplastic resin filament web on the collection net at a suction air speed of 13 m/sec to obtain a nonwoven fabric composed of a layer II-layer I laminated structure. Thereafter, calendering and sulfonation were carried out in the same manner as in Example 1 to obtain a nonwoven fabric separator.

### Example 7

A polypropylene (PP) solution was spun by a meltblown method under the condition of a spinning temperature of 220° C. and blown onto a collection net at a suction air speed of 13 m/sec to form a web, whereby a nonwoven fabric composed of a layer I single-layer structure was obtained. Thereafter, calendering and sulfonation were carried out in the same manner as in Example 1 to obtain a nonwoven fabric separator.

### Example 8

A web was directly laminated onto a continuous filament nonwoven fabric produced by the same spunbond method as in Example 1, by the same meltblown method as in Example 1 to obtain a layer II-layer I structure. A web was further laminated thereon by a meltblown method or a spunbond method to obtain a layer II-layer I-layer II structure. Thereafter, calendering and sulfonation were carried out in the same manner as in Example 1 to obtain a nonwoven fabric separator.

### Example 9

A nonwoven fabric made of staples consisting of a polypropylene resin and having a fiber diameter of 3.3 μm was sulfonated to obtain a nonwoven fabric separator.

### Example 16

A nonwoven fabric was produced in the same manner as in Example 1, and then subjected to hydrophilization in which a surfactant was applied to obtain a nonwoven fabric separator. For the surfactant, sodium dialkyl sulfosuccinate was used, and the amount applied was 0.1% with respect to the weight of the nonwoven fabric.

### Example 23

Continuous filaments having a PE/PP sheath-core structure and having a fiber diameter of 16 μm were collected on a net by a spunbond method to obtain a continuous filament nonwoven fabric. An ultrafine polypropylene nonwoven fabric was then further laminated by a meltblown method in the same manner as in Example 1 to the same continuous filament nonwoven fabric having a PE/PP sheath-core structure described above, whereby a laminated nonwoven fabric having a layer II-layer I-layer II laminate structure was obtained. Thereafter, calendering and sulfonation were carried out in the same manner as in Example 1 to obtain a nonwoven fabric separator.

### Comparative Example 1

A layer II-layer I-layer II laminated nonwoven fabric was obtained in the same manner as in Example 1, and then only calender processing was carried out to obtain a nonwoven fabric separator.

### Comparative Example 2

Except that suction air speed over the collection net during layer I formation was set to 5 m/sec, a nonwoven fabric separator was obtained in the same manner as in Example 1.

### Comparative Example 3

Using a nylon resin, a nonwoven fabric composed of a layer II-layer I-layer II laminated structure was obtained by the same method as in Example 1. Thereafter, only calender processing was carried out to obtain a nonwoven fabric separator.

TABLE 1

| | | Nonwoven | | Ultrafine | | | | | | | | |
|---|---|---|---|---|---|---|---|---|---|---|---|---|
| | | fabric | | fiber | Basis | | Apparent | Thick- | | Minimum | | |
| | Fiber | config- | Hydrophilization | diameter | weight | | density | ness | Porosity | porosity | \|Pmax\| | Tmax |
| Unit | material | uration | method | μm | g/m² | i/ii | g/cm³ | mm | % | % | dB | min |
| Example 1 | PP | II-I-II | Sulfonation | 2.5 | 40 | 0.10 | 0.33 | 0.12 | 65% | 73% | 18.4 | 0.8 |
| Example 2 | PP | II-I-II | Sulfonation | 2.5 | 40 | 0.07 | 0.29 | 0.14 | 70% | 76% | 13.5 | 0.8 |
| Example 3 | PP | II-I-II | Sulfonation | 2.5 | 40 | 0.31 | 0.36 | 0.11 | 61% | 68% | 26.3 | 0.8 |
| Example 4 | PP | II-I-II | Sulfonation | 2.5 | 40 | 0.10 | 0.33 | 0.12 | 65% | 73% | 20.7 | 1.4 |
| Example 5 | PP | II-I-II | Sulfonation | 2.5 | 40 | 0.10 | 0.33 | 0.12 | 65% | 73% | 17.2 | 0.5 |
| Example 6 | PP | II-I | Sulfonation | 2.5 | 40 | 0.31 | 0.33 | 0.12 | 65% | 73% | 18.4 | 0.8 |
| Example 7 | PP | I | Sulfonation | 2.5 | 40 | — | 0.33 | 0.12 | 65% | 73% | 30.5 | 1.3 |
| Example 8 | PP | II-I-I-II | Sulfonation | 2.5 | 40 | 0.10 | 0.33 | 0.12 | 65% | 73% | 19.2 | 0.9 |
| Example 9 | PP | I (staples) | Sulfonation | 3.3 | 40 | — | 0.33 | 0.12 | 65% | 73% | 33.2 | 3.8 |
| Example 10 | PP | II-I-II | Sulfonation | 0.8 | 40 | 0.10 | 0.33 | 0.12 | 65% | 76% | 26.9 | 0.9 |
| Example 11 | PP | II-I-II | Sulfonation | 3.1 | 40 | 0.10 | 0.33 | 0.12 | 65% | 68% | 12.9 | 0.8 |
| Example 12 | PP | II-I-II | Sulfonation | 2.5 | 15 | 0.10 | 0.13 | 0.12 | 87% | 81% | 11.8 | 0.7 |
| Example 13 | PP | II-I-II | Sulfonation | 2.5 | 70 | 0.10 | 0.58 | 0.12 | 38% | 57% | 21.4 | 1.3 |
| Example 14 | PP | II-I-II | Sulfonation | 2.5 | 40 | 0.10 | 0.57 | 0.07 | 39% | 59% | 16.2 | 0.7 |
| Example 15 | PP | II-I-II | Sulfonation | 2.5 | 40 | 0.10 | 0.17 | 0.23 | 81% | 75% | 19.7 | 1.1 |
| Example 16 | PP | II-I-II | Surfactant | 2.5 | 40 | 0.10 | 0.33 | 0.12 | 65% | 73% | 19.2 | 9.8 |
| Example 17 | PP | II-I-II | Sulfonation | 2.5 | 40 | 0.10 | 0.22 | 0.18 | 76% | 73% | 37.4 | 2.1 |
| Example 18 | PP | II-I-II | Sulfonation | 2.5 | 40 | 0.10 | 0.27 | 0.15 | 72% | 73% | 25.8 | 1.5 |
| Example 19 | PP | II-I-II | Sulfonation | 2.5 | 40 | 0.10 | 0.33 | 0.12 | 65% | 73% | 18.3 | 0.8 |
| Example 20 | PP | II-I-II | Sulfonation | 2.5 | 40 | 0.10 | 0.33 | 0.12 | 65% | 73% | 18.6 | 0.8 |
| Example 21 | PP | II-I-II | Sulfonation | 2.5 | 40 | 0.08 | 0.33 | 0.12 | 65% | 73% | 10.5 | 0.7 |
| Example 22 | PP | II-I-II | Sulfonation | 2.5 | 40 | 0.51 | 0.33 | 0.12 | 65% | 73% | 24.2 | 0.7 |
| Example 23 | PP/PE | II-I-II | Sulfonation | 2.5 | 40 | ↑ | 0.33 | 0.12 | 65% | 73% | 18.2 | 0.8 |
| | sheath core | | | | | | | | | | | |
| Example 24 | PP | II-I-II | Sulfonation | 2.5 | 40 | 0.10 | 0.33 | 0.12 | 65% | 85% | 16.8 | 0.8 |
| Example 25 | PP | II-I-II | Sulfonation | 2.5 | 40 | 0.10 | 0.33 | 0.12 | 65% | 49% | 26.8 | 0.9 |
| Example 26 | PP | II-I-II | Sulfonation | 2.5 | 40 | 0.10 | 0.33 | 0.12 | 65% | 41% | 33.8 | 1.0 |
| Comparative | PP | II-I-II | — | — | 40 | 0.10 | 0.33 | 0.12 | 65% | 73% | 56.8 | 1.2 |
| Example 1 | | | | | | | | | | | | |
| Comparative | PP | II-I-II | Sulfonation | 2.5 | 40 | 0.10 | 0.33 | 0.12 | 65% | 18% | 48.9 | 2.5 |
| Example 2 | | | | | | | | | | | | |
| Comparative | Ny | II | — | — | 40 | — | 0.33 | 0.12 | 71% | 71% | 14.2 | 18.5 |
| Example 3 | | | | | | | | | | | | |

TABLE 2

| | | | | | Thermo- | | | | | | |
|---|---|---|---|---|---|---|---|---|---|---|---|
| | | | | Tensile | compression | Compres- | Light | | Cell | Capacity | |
| | Mean flow | Bubble | Airflow | strength | bonding | sion | transmit- | Electrical | defect | retention | Cycle |
| | pore size | point | resistance | (MD) | area ratio | ratio | tance | resistance | rate | rate | charac- |
| Unit | μm | μm | kPa · s/m | N/50 mm | % | % | % | mΩ | % | % | teristics |
| Example 1 | 11.4 | 48.2 | 0.9 | 108.2 | 0 | 41.2 | 82 | 13.2 | 96.4 | 91.2 | Excellent |
| Example 2 | 16.2 | 67.1 | 0.7 | 111.3 | 0 | 40.3 | 88 | 11.1 | 93.1 | 95.3 | Excellent |
| Example 3 | 9.8 | 35.9 | 1.9 | 103.5 | 0 | 42.5 | 76 | 16.8 | 97.7 | 89.2 | Excellent |
| Example 4 | 10.7 | 39.2 | 1.0 | 115.2 | 0 | 41.3 | 83 | 19.5 | 96.2 | 91.2 | Excellent |
| Example 5 | 12.3 | 50.4 | 0.7 | 99.5 | 0 | 43.5 | 89 | 9.9 | 94.0 | 94.2 | Excellent |
| Example 6 | 11.2 | 45.6 | 0.9 | 112.5 | 0 | 43.2 | 81 | 13.1 | 96.5 | 90.6 | Excellent |
| Example 7 | 3.8 | 23.2 | 14.8 | 34.8 | 0 | 40.8 | 68 | 18.1 | 98.1 | 88.4 | Good |
| Example 8 | 10.5 | 26.4 | 0.8 | 115.4 | 0 | 43.2 | 81 | 13.1 | 94.8 | 91.8 | Excellent |
| Example 9 | 14.8 | 31.7 | 1.2 | 111.4 | 0 | 35.3 | 66 | 21.5 | 96.9 | 82.5 | Good |
| Example 10 | 2.8 | 9.5 | 3.7 | 94.8 | 0 | 41.3 | 73 | 17.2 | 97.4 | 90.1 | Excellent |
| Example 11 | 19.8 | 62.3 | 0.1 | 87.5 | 0 | 40.5 | 89 | 11.8 | 93.1 | 93.5 | Excellent |
| Example 12 | 13.5 | 58.3 | 0.7 | 102.1 | 0 | 48.2 | 91 | 11.5 | 95.5 | 91.5 | Excellent |
| Example 13 | 10.2 | 43.5 | 1.8 | 132.4 | 0 | 38.9 | 79 | 16.9 | 96.7 | 90.3 | Excellent |
| Example 14 | 10.1 | 42.3 | 0.8 | 125.4 | 0 | 39.2 | 81 | 13.8 | 96.0 | 91.1 | Excellent |
| Example 15 | 14.4 | 51.2 | 1.1 | 109.2 | 0 | 47.9 | 85 | 15.4 | 96.8 | 90.9 | Excellent |
| Example 16 | 11.4 | 48.2 | 0.9 | 113.5 | 0 | 41.2 | 82 | 24.3 | 95.3 | 90.8 | Excellent |
| Example 17 | 11.0 | 45.2 | 0.9 | 105.2 | 19 | 49.9 | 71 | 21.8 | 96.1 | 81.2 | Good |
| Example 18 | 11.8 | 49.3 | 1.0 | 103.6 | 12 | 43.9 | 75 | 17.7 | 95.8 | 89.5 | Excellent |
| Example 19 | 11.2 | 47.2 | 0.8 | 114.3 | 0 | 53.8 | 84 | 13.4 | 96.6 | 93.2 | Excellent |
| Example 20 | 11.5 | 49.5 | 0.9 | 109.5 | 0 | 36.2 | 81 | 14.9 | 95.9 | 83.5 | Excellent |
| Example 21 | 11.8 | 40.5 | 0.8 | 105.9 | 0 | 42.8 | 92 | 11.8 | 94.1 | 95.6 | Excellent |
| Example 22 | 11.3 | 49.2 | 1.0 | 108.2 | 0 | 41.9 | 73 | 18.3 | 97.8 | 88.2 | Excellent |
| Example 23 | 11.2 | 49.4 | 1.1 | 168.3 | 0 | 40.5 | 83 | 13.9 | 96.5 | 93.4 | Excellent |
| Example 24 | 16.9 | 69.5 | 0.6 | 105.6 | 0 | 45.6 | 88 | 10.8 | 92.2 | 97.2 | Good |
| Example 25 | 10.8 | 45.3 | 1.6 | 109.3 | 0 | 40.6 | 79 | 13.9 | 97.1 | 90.3 | Excellent |
| Example 26 | 9.2 | 38.9 | 2.2 | 111.5 | 0 | 49.4 | 76 | 18.8 | 98.8 | 85.4 | Good |
| Comparative | 11.4 | 48.2 | 0.9 | 108.2 | 0 | 40.5 | 82 | ≥100 | 92.5 | 48.2 | Poor |
| Example 1 | | | | | | | | | | | |
| Comparative | 5.3 | 28.9 | 4.5 | 122.9 | 0 | 51.2 | 71 | 32.9 | 94.8 | 62.9 | Poor |
| Example 2 | | | | | | | | | | | |
| Comparative | 35.2 | 108.4 | 0.1 | 75.3 | 0 | 42.2 | 91 | 22.9 | 75.2 | 68.9 | Poor |
| Example 3 | | | | | | | | | | | |

### INDUSTRIAL APPLICABILITY

The nonwoven fabric separator of the present invention comprises an optimized material and a highly controlled structure, and thus an aspect thereof has excellent ion permeability, liquid retention, electrical insulation, and chemical stability, and also has excellent processability in cells.

1. A nonwoven fabric separator comprising a polyolefin-based nonwoven fabric, wherein the nonwoven fabric separator satisfies permeability parameters of formulas (1) and (2) below:

|Pmax|≤38.5 dB (1)
Tmax≤11.5 min (2)
where in the formulas, both Pmax and Tmax are parameters indicating permeability, Pmax indicates attenuation of ultrasonic transmission when the nonwoven fabric separator is filled with water, and Tmax indicates time until the nonwoven fabric separator is filled with water.

2. The nonwoven fabric separator according to claim 1, wherein the nonwoven fabric separator is a filament nonwoven fabric separator.

3. The nonwoven fabric separator according to claim 1, wherein the nonwoven fabric separator comprises ultrafine fibers having a fiber diameter of 0.1 μm to 5 μm.

4. The nonwoven fabric separator according to claim 3, wherein the nonwoven fabric separator is composed of at least two layers, comprising a nonwoven fabric layer (layer I) made of the ultrafine fibers and a nonwoven fabric layer (layer II) made of fibers having a fiber diameter of more than 5 μm and 30 μm or less.

5. The nonwoven fabric separator according to claim 4, wherein the nonwoven fabric separator is composed of three layers having two layers of the layer II and the layer I disposed between the layers II.

6. The nonwoven fabric separator according to claim 4, wherein the layer I is a meltblown nonwoven fabric layer.

7. The nonwoven fabric separator according to claim 4, wherein a ratio (i)/(ii) of a basis weight (i) of the layer I to a basis weight (ii) of the layer II is 1/20 to 2/1.

8. The nonwoven fabric separator according to claim 1 having a mean flow pore size of 0.1 μm to 50 μm and a bubble point of 5 μm to 100 μm.

9. The nonwoven fabric separator according to claim 1 having an airflow resistance of 0.1 kPa·s/m to 15 kPa·s/m.

10. The nonwoven fabric separator according to claim 1 having a porosity of 30% to 95%.

11. The nonwoven fabric separator according to claim 1 having a tensile strength of 15 N/50 mm to 300 N/50 mm.

12. The nonwoven fabric separator according to claim 1 comprising a hydrophilic functional group.

13. The nonwoven fabric separator according to claim 1 having a thermocompression bonding area ratio of 20% or less.

14. The nonwoven fabric separator according to claim 1 having a compression ratio of 35% or greater.

15. The nonwoven fabric separator according to claim 1 having a light transmittance of 70% or greater.

16. The nonwoven fabric separator according to claim 1, wherein a lowest porosity in a porosity distribution in a thickness direction is 20% or greater.
